(19) United States
(12) Patent Application Publication
(10) Pub. No.: US 2025/0005851 A1
(43) Pub. Date: Jan. 2, 2025

(54) GENERATING FACE MODELS BASED ON IMAGE AND AUDIO DATA

(71) Applicant: QUALCOMM Incorporated, San Diego, CA (US)

(72) Inventors: Arpit BHATNAGAR, Bengaluru (IN); Chiranjib CHOUDHURI, Bangalore (IN); Anupama S, Chennai (IN); Avani RAO, Bangalore (IN); Ajit Deepak GUPTE, Bangalore (IN)

(21) Appl. No.: 18/345,843

(22) Filed: Jun. 30, 2023

(51) Int. Cl. G06T 17/00; G06T 15/04; G06T 15/10; G10L 15/02; G10L 15/22; G10L 25/18

(52) U.S. Cl. CPC G06T 17/00; G06T 15/04; G06T 15/10; G10L 15/02; G10L 15/22; G10L 25/18

(57) ABSTRACT

Systems and techniques are described herein for generating models of faces. For instance, a method for generating models of faces is provided. The method may include obtaining one or more images of one or both eyes of a face of a user; obtaining audio data based on utterances of the user; and generating, using a machine-learning model, a three-dimensional model of the face of the user based on the one or more images and the audio data.

### TECHNICAL FIELD

The present disclosure generally relates to generating face models based on image and audio data. For example, aspects of the present disclosure include systems and techniques for generating a three-dimensional model of a face of a person based one or more images of eyes of the face and based on audio data representative of utterances of the person.

### BACKGROUND

A three-dimensional (3D) face model can represent geometry and texture of a face of a person and can be photorealistic. 3D face models can be used in variety of applications (e.g., virtual conferencing, gaming, facial rigging, and/or avatar animation). 3D face models can be generated using one or more photographs and/or can be modeled directly through a user interface. For example, a morphable face model (e.g., a 3D morphable model (3DMM)) can be derived from an example set of 3D face models by transforming shape and texture of the example into a vector space representation. Using linear combination of the prototypes new faces and expressions can be modeled. Face recognition, reconstructing face from single or multiple images, face animations, etc. can be performed using 3DMM models.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

Systems and techniques are described herein for generating models of faces. According to at least one example, an apparatus for generating models of faces is provided. The apparatus includes at least one memory and at least one processor coupled to the at least one memory. The at least one processor is configured to: obtain one or more images of one or both eyes of a face of a user; obtain audio data based on utterances of the user; and generate, using a machine-learning model, a three-dimensional model of the face of the user based on the one or more images and the audio data.

In another example, a method for generating models of faces is provided. The method includes: obtaining one or more images of one or both eyes of a face of a user; obtaining audio data based on utterances of the user; and generating, using a machine-learning model, a three-dimensional model of the face of the user based on the one or more images and the audio data.

In another example, a non-transitory computer-readable medium is provided that has stored thereon instructions that, when executed by at least one processor, cause the at least one processor to: obtain one or more images of one or both eyes of a face of a user; obtain audio data based on utterances of the user; and generate, using a machine-learning model, a three-dimensional model of the face of the user based on the one or more images and the audio data.

As another example, an apparatus for generating models of faces is provided. The apparatus includes: means for obtaining one or more images of one or both eyes of a face of a user; means for obtaining audio data based on utterances of the user; and means for generating, using a machine-learning model, a three-dimensional model of the face of the user based on the one or more images and the audio data.

In some aspects, one or more of the apparatuses described herein is, can be part of, or can include a mobile device (e.g., a mobile telephone or so-called “smart phone”, a tablet computer, or other type of mobile device), an extended reality device (e.g., a virtual reality (VR) device, an augmented reality (AR) device, or a mixed reality (MR) device), a vehicle (or a computing device or system of a vehicle), a smart or connected device (e.g., an Internet-of-Things (IoT) device), a wearable device, a personal computer, a laptop computer, a video server, a television (e.g., a network-connected television), a robotics device or system, or other device. In some aspects, each apparatus can include an image sensor (e.g., a camera) or multiple image sensors (e.g., multiple cameras) for capturing one or more images. In some aspects, each apparatus can include one or more displays for displaying one or more images, notifications, and/or other displayable data. In some aspects, each apparatus can include one or more speakers, one or more light-emitting devices, and/or one or more microphones. In some aspects, each apparatus can include one or more sensors. In some cases, the one or more sensors can be used for determining a location of the apparatuses, a state of the apparatuses (e.g., a tracking state, an operating state, a temperature, a humidity level, and/or other state), and/or for other purposes.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative examples of the present application are described in detail below with reference to the following figures:

FIG. 1 is a block diagram illustrating a system for generating a 3D facial model 108.

FIG. 2 includes two images that illustrate a two-dimensional (2D) facial image and a corresponding three-dimensional (3D) facial model.

FIG. 3 includes sample images captured by cameras positioned on ahead-mounted device (HMD).

FIG. 4 is a block diagram illustrating a system for generating a 3D model based on one or more eye image(s) and audio data, according to various aspects of the present disclosure.

FIG. 5 is a block diagram illustrating a system for generating a 3D model based on one or more eye image(s), audio data, and mouth image, according to various aspects of the present disclosure.

FIG. 6 is a block diagram illustrating a system for generating a view-dependent (VD) 3D model based on one or more eye image(s), audio data, and view, and optionally mouth image, according to various aspects of the present disclosure.

FIG. 7 is a block diagram illustrating a system 700 for generating a 3D model based on one or more eye image(s), audio data, and optionally based on view and/or mouth image, according to various aspects of the present disclosure.

FIG. 8 is a block diagram illustrating a system for generating a 3D model based on one or more eye image(s), audio data, and optionally based on view and/or mouth image, according to various aspects of the present disclosure.

FIG. 9 is a flow diagram illustrating another example process for generating a model of a face based on images and audio data, in accordance with aspects of the present disclosure.

FIG. 10 is a block diagram illustrating an example of a deep learning neural network that can be used to implement a perception module and/or one or more validation modules, according to some aspects of the disclosed technology.

FIG. 11 is a block diagram illustrating an example of a convolutional neural network (CNN), according to various aspects of the present disclosure; and

FIG. 12 is a block diagram illustrating an example computing-device architecture of an example computing device which can implement the various techniques described herein.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the exemplary aspects will provide those skilled in the art with an enabling description for implementing an exemplary aspect. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage, or mode of operation.

Three-dimensional (3D) object reconstruction can be performed to generate 3D models of scenes or objects. For example, 3D face reconstruction can be performed to generate a 3D model of a face. Performing 3D object reconstruction from one or more images can be challenging. For example, 3D face reconstruction can be difficult based on the need to reconstruct a geometry (e.g., shape) a facial expression of the face. In addition, it can be difficult to accurately reconstruct facial expressions for portions of the face that can experience high variations in appearance. In one illustrative example, the eyes of a face can be moved to extreme gaze directions (e.g., looking to one side, crossing eyes, or the like). In another illustrative example, the upper and lower lips of the mouth of a face are controlled by muscles that allow a large variety of mouth shapes that are difficult to reconstruct (e.g., smiling, frowning, baring teeth, twisting lips, etc.).

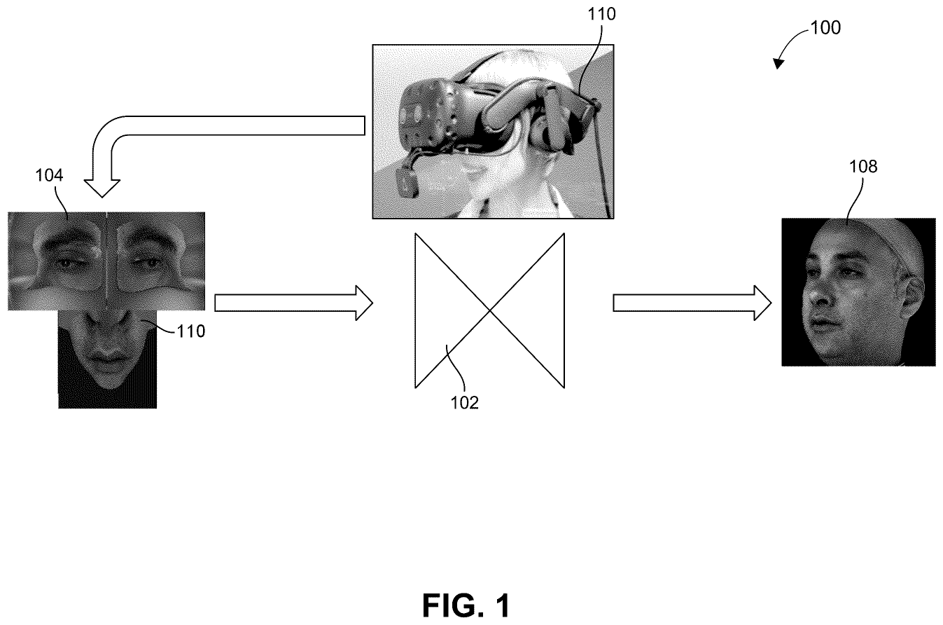

FIG. 1 is a block diagram illustrating an example of a system 100 for generating a 3D facial model 108 for a face of a user wearing a head-mounted extended reality (XR) system 110. As shown in FIG. 1, a 3D model generator 102 can utilize input frames such as images of eyes 104 of the face and an image of a mouth 110 of the face to generate the 3D facial model 108. 3D facial model 108 may be a 3D morphable model (3DMM) which may represent the geometry of the user's head. A 3D-model-fitting engine can also generate and/or apply a texture to the underlying 3D model (e.g., the 3D facial model 108) to provide a digital representation of the user wearing the head-mounted XR system 110. In the present disclosure, the term “XR” may include virtual reality (VR), Augmented Reality (AR), Mixed Reality (MR), or any combination thereof.

As noted previously, a 3D model of a face may in some cases be a 3DMM. For instance, a 3DMM (denoted as 3DMM S) generated using a 3D model fitting technique (e.g., a 3DMM fitting technique) can be a statistical model representing a 3D geometry of an object (e.g., a face). For instance, the 3DMM S can be represented by a linear combination of a mean face S₀ with basis terms (also referred to as basis vectors) for facial shape U₁ and facial expressions Vⱼ with coefficients for facial shape aᵢ and facial expressions bⱼ, for example, as follows:

$$S = {S}_{0} + {\sum }_{i = 1}^{M} {a}_{i} \cdot {U}_{i} + {\sum }_{j = 1}^{N} {b}_{j} \cdot {V}_{j}$$

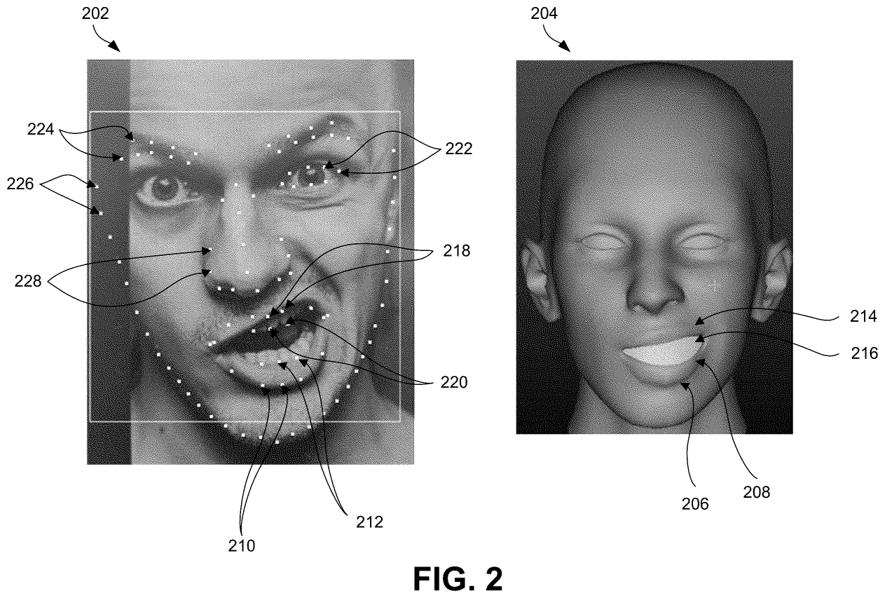

FIG. 2 includes two images that illustrate a two-dimensional (2D) facial image 202 and a corresponding 3D facial model 204 (which may be a 3D morphable model (3DMM)) generated from a 2D facial image 202. As illustrated in FIG. 2, white dots overlaid on 2D facial image 202 can represent a projection of 3D vertices of 3D facial model 204 back onto the original 2D facial image 202 used to generate the 3D facial model 204. For instance, in the illustration of FIG. 2, points corresponding to 3D vertices of major features of the 3D facial model 204 (which can be referred to as landmarks or 2D landmarks) are depicted as white dots. As shown, landmarks 210, 212, 218, 220, 222, 224, 226, and 228 are included for the outlines of lips, nose, mouth, eyes, eyebrows, nose, among others. Although 3D facial model 204 may contain a much larger number of vertices, for purposes of illustration, only a small number of projected 3D vertices corresponding to the above listed facial features are shown. In the illustrated example of FIG. 2, landmarks corresponding to the inner contour 208 of the lower lip of 3D facial model 204 projected onto a 2D image can include landmarks 212. Similarly, the landmarks corresponding to the outer contour 206 of the lower lip of 3D facial model 204 can include landmarks 210.

FIG. 2 also illustrates outer contour 214 and inner contour 216 of the upper lip of 3D facial model 204. In some examples, landmarks corresponding to outer contour 214 of the upper lip can include landmarks 218 and 224 and landmarks corresponding to the inner contour 216 of the upper lip can include landmarks 220. Additional landmarks projected from 3D facial model 204 can include landmarks 222 corresponding to the left eye, landmarks 224 corresponding to the right eyebrow, landmarks 226 corresponding to the overall face outline, and landmarks 228 corresponding to the nose. As noted above, each of the landmarks 220, 222, 224, 226, and 228 can result from a projection of 3D facial model 204 onto 2D facial image 202.

In some aspects, 3D facial model 204 can include a representation of a facial expression in 2D facial image 202. In one illustrative example, the facial expression representation can be formed from blendshapes. Blendshapes can semantically represent movement of muscles or portions of facial features (e.g., opening/closing of the jaw, raising/lowering of an eyebrow, opening/closing eyes, etc.). In some cases, each blendshape can be represented by a blendshape coefficient paired with a corresponding blendshape vector.

In some examples, 3D facial model 204 can include a representation of the facial shape in 2D facial image 202. In some cases, the facial shape can be represented by a facial shape coefficient paired with a corresponding facial shape vector. In some implementations a 3D model engine (e.g., 3D model generator 102) can be trained (e.g., during a training process) to enforce a consistent facial shape (e.g., consistent facial shape coefficients) for a 3D facial model regardless of a pose (e.g., pitch, yaw, and roll) associated with the 3D facial model. For example, when the 3D facial model is rendered into a 2D image for display, the 3D facial model can be projected onto a 2D image using a projection technique. While a 3D model engine that enforces a consistent facial shape independent of pose, the projected 2D image may have varying degrees of accuracy based on the pose of the 3D facial model captured in the projected 2D image.

One illustrative example of a technique for generating a view-dependent (VD) 3DMM of a face (e.g., that may be performed by 3D model generator 102 of FIG. 1) includes using a VD 3DMM neural-network encoder to infer a pose-irrelevant motion code (e.g., a latent representation) from images from a local camera of a head-mounted device (HMD) (e.g., referred to as a Head Mount Camera (HMC))) and further estimate VD 3DMM coefficients conditioned on target pose. The VD 3DMM network may be trained by iteratively updating parameters (e.g., weights, biases, etc.) of the VD 3DMM network to cause the VD 3DMM network to output an estimated mesh that is more similar to a ground truth mesh. The VD 3DMM shape can be aligned to a UV space and can then be passed the VD 3DMM shape through an image translation Unet to obtain a UV color texture. The Unet may be trained by minimizing a pixel error between a ground truth image and a synthesized image that was rendered by rasterizing synthesized UV texture on VD 3DMM geometry.

Some techniques for generating a 3DMM may not be able to accurately generate 3DMMs of faces based on images from one or more cameras of an HMD. For example, lip and/or mouth reconstruction based on images from a top view of the mouth may not accurately portray the actual lip and/or mouth of a user of the HMD. Further, such reconstructions may visually appear unrealistic when audio is played while the reconstructions are displayed and animated.

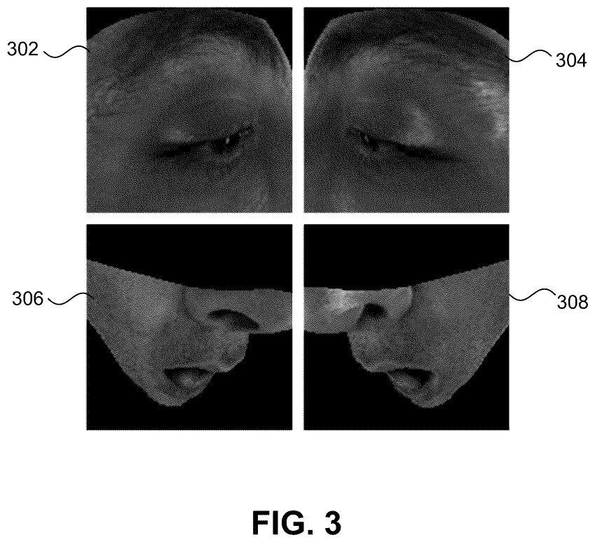

For instance, a virtual reality (VR) HMD includes cameras to capture eye and mouth images. As an illustrative example, FIG. 3 includes sample images captured by cameras positioned on an HMD. As shown, the cameras of the HMD can capture a right eye image 302, a left eye image 304, a right mouth image 306, and a left mouth image 308 (e.g., each captured by a separate camera on an HMD). It may be difficult, or impossible, to accurately reconstruct a mouth portion of a 3DMM of a face based on the right mouth image 306 and left mouth image 308 because of the oblique view of the mouth in the right mouth image 306 and left mouth image 308.

In another example, an augmented reality (AR) HMD may not include mouth-facing cameras. AR HMDs typically have a light-weight form factor, which poses battery consumption and thermal dissipation challenges. Adding one or more additional cameras to an AR HMD to capture images of a mouth of a user of the AR HMD may increase cost, form factor, and/or battery consumption and may thus be undesirable. It may be difficult, or impossible, to generate complete facial avatars and/or to accurately render expressions without images of the mouth (e.g., using only eye images).

Systems, apparatuses, methods (also referred to as processes), and computer-readable media (collectively referred to herein as “systems and techniques”) are described herein for generating a three-dimensional (3D) model of a face based on images and audio data. According to some aspects, the systems and techniques described herein can obtain one or more images of one or both eyes of a face of a user (e.g., using cameras of an HMD), such as the right eye image 302 and/or left eye image 304 illustrated in FIG. 3. The systems and techniques may further obtain audio data based on utterances of the user (e.g., using one or more microphones of the HMD). The systems and techniques can further generate, such as using a machine-learning model, a 3D model (e.g., a 3DMM) of the face of the user based on the one or more images and the audio data. For instance, the systems and techniques can derive a view dependent (VD) 3DMM face mesh using images from a camera of the HMD (e.g., an HMC) and the audio data. In one illustrative example, the 3DMM face mesh can provide a more accurate facial avatar.

The systems and techniques can be used for any suitable HMD. For instance, for AR HMDs (e.g., AR glasses), audio input can be used along with eye images from one or more cameras of the AR HMD to generate facial avatar and expressions. In another example, for VR HMDs, audio input can be used along with images from one or more cameras of the VR HMD as additional modality to improve the accuracy of expressions for facial avatar.

In some aspects, the systems and techniques may use perception-based representations of the audio data. In the present disclosure, the term “perception-based,” and like terms, may refer to representations of audio data (e.g., utterances) that are arranged and/or scaled according to human perception and/or according to language perception specifically. Additionally, or alternatively, a perception-based representation of audio data may include a representation based on (e.g., focused on) perceptually-relevant frequencies and/or perceptually-relevant amplitudes). For example, audio data may be transformed from the time domain into the frequency domain (e.g., using a Fourier transform), windowed (e.g., by identifying time-based portions of the audio data in the frequency domain), and scaled (e.g., according to a logarithmic scale). A perception-based representation of audio data may be based on a human's ability to perceive sound and/or interpret language based on sound. A Mel spectrogram representation is an example of a perception-based representation of audio data. A Mel spectrogram representation is a time-frequency representation with perceptually-relevant amplitude representation and perceptually relevant-frequency representation. Audio data represented in a Mel spectrogram may be scaled according to the Mel scale, which may be used to convert frequencies to perceptually relevant frequencies (e.g., Mel frequencies). For instance, equal distances on the Mel scale can have a same perceptual distance. The Mel scale can also have a perceptually-informed scale for pitch. The systems and techniques may extract audio features from a perception-based representation of audio data (e.g., a Mel spectrogram).

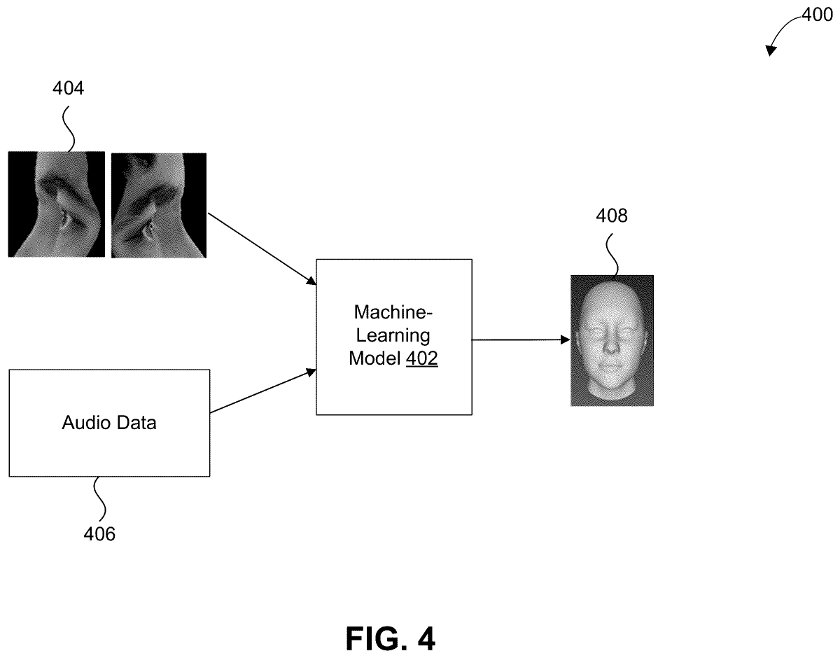

FIG. 4 is a block diagram illustrating a system 400 for generating a 3D model 408 based on one or more eye image(s) 404 and audio data 406, according to various aspects of the present disclosure. System 400 may be implemented in, or for, an HMD (e.g., XR system 110 of FIG. 1) or without a mouth-facing camera (e.g., an AR HMD).

System 400 may obtain eye image(s) 404 which may include images of one or both eyes of a face of a user of the HMD. Eye image(s) 404 may be captured by eye-facing cameras of the HMD. One illustrative example of eye images includes the image 302 and/or the image 304 of FIG. 3.

As shown in FIG. 4, system 400 also obtains audio data 406, which may be based on utterances of the user. Audio data 406 may be a perception-based representation of recorded audio data. For example, audio data 406 may be a Mel spectrogram representation of recorded audio data. In some cases, the audio data may be recorded using one or more microphones on the HMD.

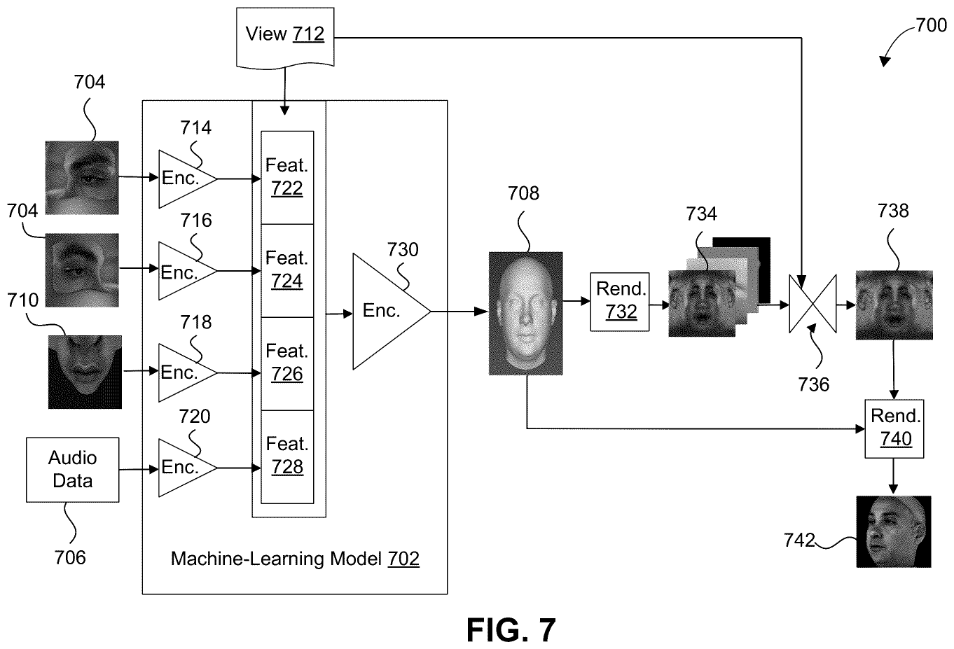

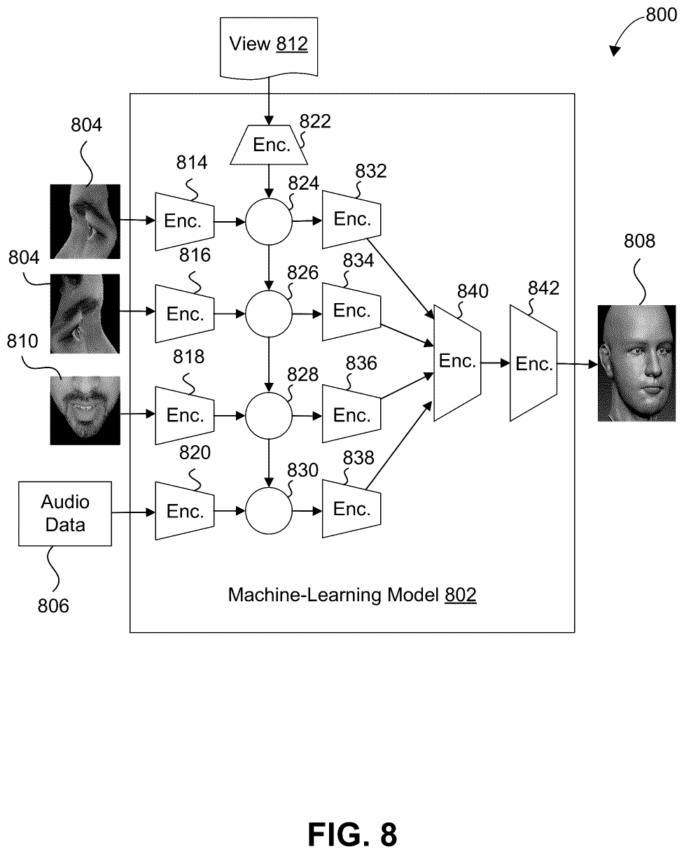

System 400 may generate, using a machine-learning model 402, 3D model 408 of the face of the user based on eye image(s) 404 and audio data 406. 3D model 408 may be a 3DMM (of which 3D facial model 204 of FIG. 2 is an example). Additionally, or alternatively, 3D model 408 may be, or may include, coefficients of a 3DMM. Two illustrative examples of generating respective 3D models based on eye image(s) and audio data are described below with respect to FIG. 7 and FIG. 8. A mouth portion of 3D model 408 of the face may be based on audio data 406. For example, machine-learning model 402 may generate a lower half (e.g., a mouth portion) of 3D model 408 based on audio data 406.

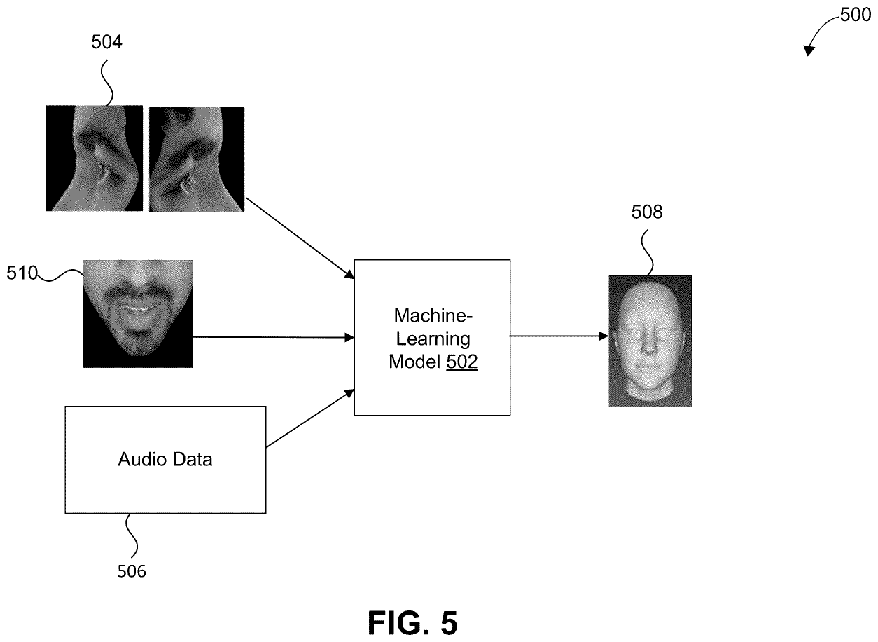

FIG. 5 is a block diagram illustrating a system 500 for generating a 3D model 508 based on one or more eye image(s) 504, audio data 506, and mouth image 510, according to various aspects of the present disclosure. System 500 may be implemented in, or for, an HMD (e.g., XR system 110 of FIG. 1) with a mouth-facing camera (e.g., a VR HMD).

System 500 may obtain eye image(s) 504. For example, the eye image(s) 504 may include images of one or both eyes of a face of a user (e.g., images 302 and/or 304 of FIG. 3) of the HMD. Eye image(s) 504 may be captured by eye-facing cameras of the HMD.

System 500 may obtain audio data 506. The audio data 506 may be based on utterances of the user. Audio data 506 may be a perception-based representation of recorded audio data. For example, audio data 506 may be a Mel spectrogram representative of recorded audio data. The audio data may be recorded using a microphone on the HMD.

System 500 may obtain mouth image 510. The mouth image 510 may be an image of a mouth portion of the face of the user. Mouth image 510 may be captured by a mouth-facing camera of the HMD.

System 500 may generate, using a machine-learning model 502, 3D model 508 of the face of the user based on eye image(s) 504, audio data 506, and mouth image 510. 3D model 508 may be a 3DMM (of which 3D facial model 204 of FIG. 2 is an example). Additionally, or alternatively, 3D model 508 may be, or may include, coefficients of a 3DMM. Two illustrative examples of generating respective 3D models based on eye image(s) and audio data are described below with respect to FIG. 7 and FIG. 8. A mouth portion of 3D model 508 of the face may be based on audio data 506 and mouth image 510. For example, machine-learning model 502 may generate a lower half (e.g., a mouth portion) of 3D model 508 based on audio data 506 and based on mouth image 510.

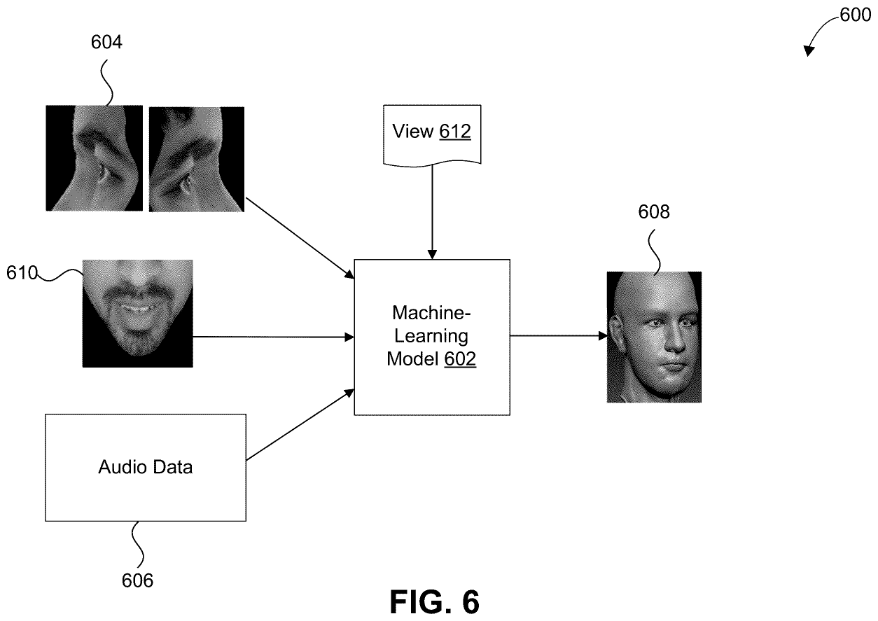

FIG. 6 is a block diagram illustrating a system 600 for generating a view-dependent (VD) 3D model 608 based on one or more eye image(s) 604, audio data 606, and view 612, and optionally mouth image 610, according to various aspects of the present disclosure. System 600 may be implemented in, or for, an HMD (e.g., XR system 110 of FIG. 1) with, or without, a mouth-facing camera (e.g., a VR HMD or an AR HMD).

System 600 may obtain eye image(s) 604 which may include one or more images of one or both eyes of a face of a user of the HMD. Eye image(s) 604 may be captured by eye-facing cameras of the HMD (e.g., XR system 110).

System 600 may obtain audio data 606, which may be based on utterances of the user. Audio data 606 may be a perception-based representation of recorded audio data (e.g., a Mel spectrogram representative of recorded audio data). The audio data may be recorded using one or more microphones on the HMD.

In some aspects, system 600 may obtain mouth image 610. The mouth image 610 may be an image of a mouth of the face of the user. Mouth image 610 may be captured by one or more mouth-facing cameras of the HMD. Mouth image 610 is optional in system 600. For instance, in some cases, mouth image 610 is not provided as input to machine-learning model 602 for generating 3D model 608.

System 600 may obtain view 612 which may be indicative of an angle from which the face modeled by VD 3D model 608 is to be viewed when rendered as a two-dimensional (2D) image. In some cases, view 612 may include angles (e.g., a pitch, a yaw, and/or a roll) relative to a point of VD 3D model 608. Such angles may represent a point from which the face modeled by VD 3D model 608 is to be viewed when VD 3D model 608 is rendered as a 2D image. In some cases, view 612 may include angles (e.g., a pitch, a yaw, and/or a roll) indicating an orientation of the face modeled by VD 3D model 608 (e.g., a pose of the face modeled by VD 3D model 608).

System 600 may generate, using a machine-learning model 602, VD 3D model 608 of the face of the user based on eye image(s) 604, audio data 606, and view 612, and optionally mouth image 610. VD 3D model 608 may be a 3DMM (of which 3D facial model 204 of FIG. 2 is an example). Additionally, or alternatively, VD 3D model 608 may be, or may include, coefficients of a 3DMM. Two illustrative examples of generating respective 3D models based on eye image(s) and audio data are described below with respect to FIG. 7 and FIG. 8. A mouth portion of VD 3D model 608 of the face may be based on audio data 606 and optionally mouth image 610. For example, machine-learning model 602 may generate a lower half (e.g., a mouth portion) of VD 3D model 608 based on audio data 606 and optionally based on mouth image 610.

FIG. 7 is a block diagram illustrating a system 700 for generating a 3D model 708 based on one or more eye image(s) 704, audio data 706, and optionally based on view 712 and/or mouth image 710, according to various aspects of the present disclosure. System 700 may be implemented in, or for, an HMD (e.g., XR system 110 of FIG. 1) with a mouth-facing camera (e.g., a VR HMD) or an HMD without a mouth-facing camera (e.g., an AR HMD).

System 700 may obtain eye image(s) 704 which may include one or more images of one or both eyes of a face of a user of the HMD. Eye image(s) 704 may be captured by one or more eye-facing cameras of the HMD.

System 700 may obtain audio data 706. Audio data 706 may be based on utterances (e.g., spoken words and/or vocal sounds) of the user. Audio data 706 may be a perception-based representation of recorded audio data (e.g., a Mel spectrogram). The audio data may be recorded using one or more microphones on the HMD.

In some aspects, system 700 may obtain mouth image 710. Mouth image 710 may be an image of a mouth of the face of the user, which may be captured by a mouth-facing camera of the HMD. Mouth image 710 is optional in system 700. For instance, in some cases, mouth image 610 is not provided as input to machine-learning model 602 for generating 3D model 608.

In some aspects, system 700 may obtain view 712. View 712 may be indicative of an angle from which the face modeled by VD 3D model 708 is to be viewed when rendered as a two-dimensional (2D) image. In some cases, view 712 may include angles (e.g., a pitch, a yaw, and/or a roll) relative to a point (e.g., a center point) of VD 3D model 708. Such angles may represent a point from which the face modeled by VD 3D model 708 is to be viewed when VD 3D model 708 is rendered as a 2D image (e.g., as rendered image 742). In some cases, view 712 may include angles (e.g., a pitch, a yaw, and/or a roll) indicating an orientation of the face modeled by VD 3D model 708 (e.g., a pose of the face modeled by VD 3D model 708). View 712 is optional in system 700. For instance, in some cases, view 712 is not provided as input to machine-learning model 702 for generating 3D model 708.

System 700 may generate, using a machine-learning model 702, 3D model 708 of the face of the user based on eye image(s) 704, audio data 706, and optionally view 712, and/or mouth image 710. 3D model 708 may be a 3DMM (of which 3D facial model 204 of FIG. 2 is an example). Additionally, or alternatively, 3D model 708 may be, or may include, coefficients of a 3DMM. In some aspects, 3D model 708 may be view dependent. For example, in cases in which view 712 is obtained, 3D model 708 may be view dependent. In other cases, (e.g., when view 712 is not provided as an input to machine-learning model 702) 3D model 708 may not be view dependent. A mouth portion of VD 3D model 708 of the face may be based on audio data 706 and optionally mouth image 710. For example, machine-learning model 702 may generate a lower half (e.g., a mouth portion) of VD 3D model 708 based on audio data 706 and optionally based on mouth image 710.

Machine-learning model 702 is an example of the machine learning model 402 of FIG. 4, machine learning model 502 of FIG. 5, and/or the machine learning model 602 of FIG. 6. In some cases, machine-learning model 702 may include one or more machine-learning encoders (e.g., neural network encoders). For example, machine-learning model 702 may include an encoder 714 to generate image-based features 722 based on one of eye image(s) 704, an encoder 716 to generate image-based features 724 based on another one of eye image(s) 704, an encoder 720 to generate features 728 based on audio data 706, and optionally an encoder 718 to generate image-based features 726 based on mouth image 710. Further, machine-learning model 702 may include an encoder 730 that may encode features 722, features 724, features 728, and optionally features 726 and/or features based on view 712 to generate 3D model 708. Each of encoder 714, encoder 716, encoder 718, encoder 720, and encoder 730 may include one or more convolutional neural-network layers, pooling layers, non-linear layers, etc. Prior to being encoded by encoder 730, features 722, features 724, features 728, and optionally features 726 and/or features based on view 712 may be combined (e.g., concatenated together).

System 700 may include a renderer 732. In some cases, renderer 732 may be, or may include, a machine learning model (e.g., a neural network). The renderer 732 can be used to generate UV maps 734 based on 3D model 708. UV maps 734 may be, or may include, 2D images (or bitmaps) that record and/or map the 3D positions of points (e.g., pixels) in UV space (e.g., 2D texture coordinate system). The U in the UV space and the V in the UV space can denote the axes of the UV face position map (e.g., the axes of a 2D texture of the face). In one illustrative example, the U in the UV space can denote a first axis (e.g., a horizontal X-axis) of the UV face position map and the V in the UV space can denote a second axis (e.g., a vertical Y-axis) of the UV face position map. In some examples, UV maps 734 may record, model, identify, represent, and/or calculate a 3D shape, structure, contour, depth and/or other details of the face (and/or a face region of the head). In some examples, 3D model 708 with the texture provided from UV maps 734 may be used to render a 3D digital representation of the face modeled by 3D model 708.

UV maps 734 may be, or may include, UV attributes derived from the 3DMM geometry of 3D model 708. The UV attributes may include a UV position map, a UV position difference map, a UV normal map, and a UV normal difference map. The UV position map may be indicative of a mapping between the UV space and the vertices of the 3DMM. The UV position difference map may be indicative of differences between a current frame and enrolled neutral frame. The UV normal map may be indicative of vectors perpendicular to points in the UV space. The UV normal difference map may be indicative of differences between a current frame and enrolled neutral frame.

System 700 may include a neural network 736. Neural network 736 may be, or may include, a machine-learning model (e.g., a UNet or encoder-decoder network). Neural network 736 can generate texture map 738 based on UV maps 734. Additionally, or alternatively, neural network 736 may receive as inputs a view vector (e.g., view 712 or a vector based on view 712) and an enrolled neutral UV texture. Texture map 738 may be, or may include, a UV texture. Texture map 738 may be view dependent, for example, texture map 738 may be based on view 712.

System 700 may include a renderer 740 which may be, or may include, a machine learning model (e.g., a neural network) and which may render rendered image 742 based on 3D model 708 and texture map 738. For example, renderer 740 may render 3D model 708 with texture map 738 applied to the surface of 3D model 708.

FIG. 8 is a block diagram illustrating a system 800 for generating a 3D model 808 based on one or more eye image(s) 804, audio data 806, and optionally based on view 812 and/or mouth image 810, according to various aspects of the present disclosure. System 800 may be implemented in, or for, an HMD with a mouth-facing camera (e.g., a VR HMD) or an HMD without a mouth-facing camera (e.g., an AR HMD).

System 800 may obtain one or more eye image(s) 804 which may include one or more images of one or both eyes of a face of a user of the HMD. Eye image(s) 804 may be captured by one or more eye-facing cameras of the HMD.

System 800 may obtain audio data 806. Audio data 806 may be based on utterances of the user of the HMD. Audio data 806 may be a perception-based representation of recorded audio data for example, a Mel spectrogram representative of recorded audio data. The audio data may be recorded using a microphone on the HMD.

In some aspects, system 800 may obtain mouth image 810 which may be an image of a mouth of the face of the user. Mouth image 810 may be captured by one or more mouth-facing cameras of the HMD. Mouth image 810 is optional in system 800. For instance, in some cases, mouth image 810 is not provided as input to machine-learning model 802 for generating 3D model 808.

In some aspects, system 800 may obtain view 812. View 812 may be indicative of an angle from which the face modeled by VD 3D model 808 is to be viewed, for example, when rendered as a two-dimensional (2D) image. In some cases, view 812 may include angles (e.g., a pitch, a yaw, and/or a roll) relative to a point of VD 3D model 808. Such angles may represent a point from which the face modeled by VD 3D model 808 is to be viewed, for example, when VD 3D model 808 is rendered as a 2D image. In some cases, view 812 may include angles (e.g., a pitch, a yaw, and/or a roll) indicating an orientation of the face modeled by VD 3D model 808 (e.g., a pose of the face modeled by VD 3D model 808). View 812 is optional in system 800. For instance, in some cases, view 812 is not provided as input to machine-learning model 802 for generating 3D model 808.

System 800 may generate, using a machine-learning model 802, 3D model 808 of the face of the user of the HMD based on eye image(s) 804, audio data 806, and optionally view 812, and/or mouth image 810. 3D model 808 may be a 3DMM (of which 3D facial model 204 of FIG. 2 is an example) for example, 3D model 808 may be, or may include, coefficients of a 3DMM. In some aspects, 3D model 808 may be view dependent. For example, in cases in which view 812 is obtained, 3D model 808 may be view dependent. In other cases, 3D model 808 may not be view dependent. A mouth portion of VD 3D model 808 of the face may be based on audio data 806 and optionally mouth image 810. For example, machine-learning model 802 may generate a mouth portion (e.g., lower half or other lower portion) of VD 3D model 808 based on audio data 806 and optionally based on mouth image 810.

Machine-learning model 802 may include one or more machine-learning encoders that may, for example, include separate branches of convolutional layers for extracting geometry information from each image (e.g., eye image(s) 804 and/or mouth image 810) and audio data 806. For example, machine-learning model 802 may include an encoder 814 to generate image-based features based on one of eye image(s) 804, an encoder 816 to generate image-based features based on another one of eye image(s) 804, an encoder 820 to generate features based on audio data 806, and optionally an encoder 818 to generate image-based features based on mouth image 810 and/or an encoder 822 to generate features based on view 812. Each of encoder 814, encoder 816, encoder 818, and encoder 820 may include one or more convolutional layers, pooling layers, and/or non-linear layers, etc. For example, each of encoder 814, encoder 816, encoder 818, and encoder 820 may include a first convolutional layer (e.g., a 7×7 convolutional layer), a first maxpool layer (e.g., a 3×3 maxpool layer), a second convolutional layer (e.g., a 1×1 convolutional layer), a third convolutional layer (e.g., a 3×3 convolutional layer), and a second maxpool layer (e.g., a 3×3 maxpool layer). Further, each of encoder 814, encoder 816, encoder 818, and encoder 820 may include one or more rectified linear unit (ReLU) layers. Encoder 822 may include a fully-connected layer and/or a spatially-tiled layer. The spatially-tiled layer may repeat the feature vector along height and width dimensions (e.g., to span the entire spatial area). The spatial tiling may be performed to distribute the feature extracted from view 812 to all spatial features extracted from images (e.g., eye image(s) 804 and/or mouth image 810).

Machine-learning model 802 may optionally include (e.g., when system 800 receives view 812) one or more combiners that may, for example, perform element-wise addition. For example, machine-learning model 802 may include a combiner 824 to combine features based on one of eye image(s) 804 (generated by encoder 814) with features based on view 812 (generated by encoder 822), a combiner 826 to combine features based on another one of eye image(s) 804 (generated by encoder 816) with features based on view 812 (generated by encoder 822), a combiner 830 to combine features based on audio data 806 (generated by encoder 820) with features based on view 812 (generated by encoder 822), and optionally a combiner 828 to combine features based on mouth image 810 (generated by encoder 818) with features based on view 812 (generated by encoder 822).

Machine-learning model 802 may optionally include (e.g., when system 800 receives view 812) one or more encoders to encode combined features (e.g., features based on any or eye image(s) 804, audio data 806, and/or mouth image 810 and features based on view 812). For example, machine-learning model 802 may include an encoder 832 to generate features based on features based on one of eye image(s) 804 combined with features based on view 812, an encoder 834 to generate features based on features based on another one of eye image(s) 804 combined with features based on view 812, an encoder 838 to generate features based on features based on audio data 806 combined with features based on view 812, and optionally an encoder 836 to generate features based on features based on mouth image 810 combined with features based on view 812. Each of encoder 832, encoder 834, encoder 836, and encoder 838 may be, or may include a neural network (e.g., a “deep” neural network). As an example, each of encoder 832, encoder 834, encoder 836, and encoder 838 may include one or more inception layers. For example, each of encoder 832, encoder 834, encoder 836, and encoder 838 may include a first inception layer (e.g., an a3 inception layer), a second inception layer (e.g., a b3 inception layer), a maxpool layer (e.g., a 3×3 maxpool layer), a third inception layer (e.g., an a4 inception layer), a fourth inception layer (e.g., a b4 inception layer), a fifth inception layer (e.g., a c4 inception layer), a sixth inception layer (e.g., a d4 inception layer), and a seventh inception layer (e.g., a e4 inception layer).

Machine-learning model 802 may include an encoder 840 that may combine and further encode the features based on eye image(s) 804, audio data 806, and optionally mouth image 810 and view 812. For example, encoder 840 may include a combiner (e.g., a concatenation block) that may combine (e.g., concatenate) the features generates by encoder 832 (which may be based one of eye image(s) 804 and view 812), encoder 834 (which may be based on another one of eye image(s) 804 and view 812), encoder 838 (which may be based on audio data 806 and view 812), and optionally encoder 836 (which may be based on mouth image 810 and view 812). Further, encoder 840 may include an encoder to encode the combined features. For example, encoder 840 may include a neural network (e.g., a “deep” neural network). As an example, encoder 840 may include one or more inception layers. For example, encoder 840 may include a maxpool layer (e.g., a 3×3 maxpool layer), a first inception layer (e.g., an a5 inception layer), a second inception layer (e.g., a b5 inception layer), an average pool layer (e.g., a 4×4 average pool layer). Machine-learning model 802 may include an encoder 842 that may include a fully-connected layer that may generate 3D model 808, which may include 3DMM coefficients, from the features generated by encoder 840.

Following the generation of 3D model 808 by machine-learning model 802, 3D model 808 may be rendered (with texture) as described above with regard to system 700. For example, though not illustrated in FIG. 8, system 800 may include renderers (e.g., similar to, or the same as, renderer 732 of FIG. 7 and renderer 740 of FIG. 7) and/or neural networks (e.g., similar to, or the same as, neural network 736 of FIG. 7).

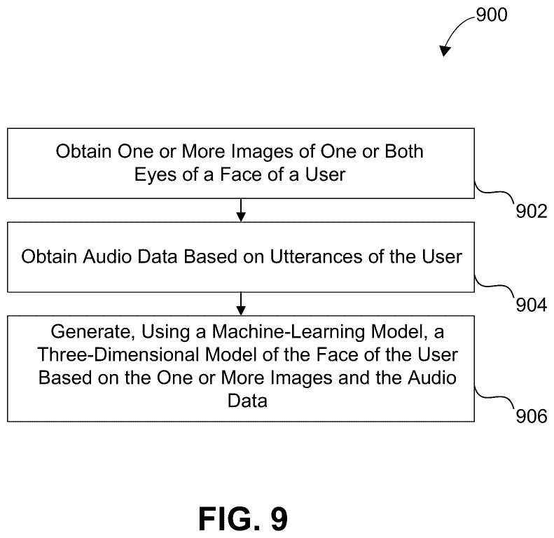

FIG. 9 is a flow diagram illustrating a process 900 for generating a model of a face based on images and audio data, in accordance with aspects of the present disclosure. One or more operations of process 900 may be performed by a computing device (or apparatus) or a component (e.g., a chipset, codec, etc.) of the computing device. The computing device may be a mobile device (e.g., a mobile phone), a network-connected wearable such as a watch, an extended reality (XR) device such as a virtual reality (VR) device or augmented reality (AR) device, a vehicle or component or system of a vehicle, a desktop computing device, a tablet computing device, a server computer, a robotic device, and/or any other computing device with the resource capabilities to perform the process 900. The one or more operations of process 900 may be implemented as software components that are executed and run on one or more processors.

At block 902, a computing device (or one or more components thereof) may obtain one or more images of one or both eyes of a face of a user. For example, machine-learning model 402 of FIG. 4 may obtain image(s) 404 of FIG. 4.

At block 904, the computing device (or one or more components thereof) may obtain audio data based on utterances of the user. For example, machine-learning model 402 may obtain audio data 406 of FIG. 4.

In some aspects, the audio data may be, or may include, perception-based representation of the utterances of the user. In some aspects, the perception-based representation of the utterances may be, or may include, a representation of the audio data based on perceptually-relevant frequencies and perceptually-relevant amplitudes. In some aspects, the audio data may be, or may include, a Mel spectrogram representative of the utterances of the user.

At block 906, the computing device (or one or more components thereof) may generate, using a machine-learning model, a three-dimensional model of the face of the user based on the one or more images and the audio data. For example, machine-learning model 402 may generate 3D model 408 of FIG. 4.

In some aspects, the computing device (or one or more components thereof) may obtain an image of at least a portion of a mouth of the face of the user. The three-dimensional model of the face may be generated based on the image of at least the portion of the mouth of the face. For example, machine-learning model 502 of FIG. 5 may generate 3D model 508 of FIG. 5 based on image(s) 504, audio data 506, and mouth image 510.

In some aspects, the three-dimensional model may be, or may include, a three-dimensional morphable model (3DMM) of the face. For example, 3D model 408 may be a 3DMM. In some aspects, the three-dimensional model may be, or may include, a plurality of vertices corresponding to points of the face. For example, 3D model 408 may be, or may include, a plurality of vertices corresponding to points of the face (e.g., as illustrated and described with regard to the example of FIG. 2). In some aspects, a mouth portion of the three-dimensional model of the face may be based on the audio data. For example, a mouth portion of d model 408 may be based on audio data 406.

In some aspects, the computing device (or one or more components thereof) may obtain a view for the three-dimensional model of the face. The three-dimensional model of the face may be generated based on the view. For example, machine-learning model 602 of FIG. 6 may obtain view 612. 3D model 608 of FIG. 6 may be based, at least in part, on view 612. The view for the three-dimensional model of the face may be based on an angle from which the three-dimensional model of the face is to be viewed.

In some aspects, the computing device (or one or more components thereof) may generate image-based features based on the one or more images of the one or both eyes of the user using one or more machine-learning encoders; generate audio features based on the audio data using a second machine-learning encoder; and generate the three-dimensional model of the face based on the image-based features and audio features using the first machine-learning encoder. For example, encoder 714 and/or encoder 716 of FIG. 7 may generate image-based features 722 and/or features 724 of FIG. 7 based on image(s) 704 of FIG. 7. Further, encoder 720 of FIG. 7 may generate features 728 of FIG. 7 based on audio data 706 of FIG. 7. Further, encoder 730 of FIG. 7 may generate 3D model 708 of FIG. 7 based on image-based features 722, features 724, and/or features 728.

In some aspects, the computing device (or one or more components thereof) may obtain a view for the three-dimensional model of the face and generate view features based on the view using a third machine-learning encoder. The three-dimensional model of the face may be generated based on the view features. For example, machine-learning model 702 of FIG. 7 may obtain view 712 of FIG. 7. Machine-learning model 702 may use an encoder (e.g., encoder 822) to generate view features. Encoder 730 may generate d model 708 based on image-based features 722, features 724, features 728, and the view features. The view for the three-dimensional model of the face may be based on an angle from which the three-dimensional model of the face is to be viewed.

In some aspects, the computing device (or one or more components thereof) may generate a UV map of the face based on the three-dimensional model of the face using a first renderer; generate a texture map based on the UV map of the face using a machine-learning encoder-decoder; and render the three-dimensional model of the face based on the three-dimensional model of the face and the texture map using a second renderer. For example, renderer 732 of FIG. 7 may generate UV maps 734 of FIG. 7 based on d model 708. Further, neural network 736 of FIG. 7 may generate texture map 738 of FIG. 7 based on UV maps 734. Further, renderer 740 of FIG. 7 may render rendered image 742 based on d model 708 and texture map 738.

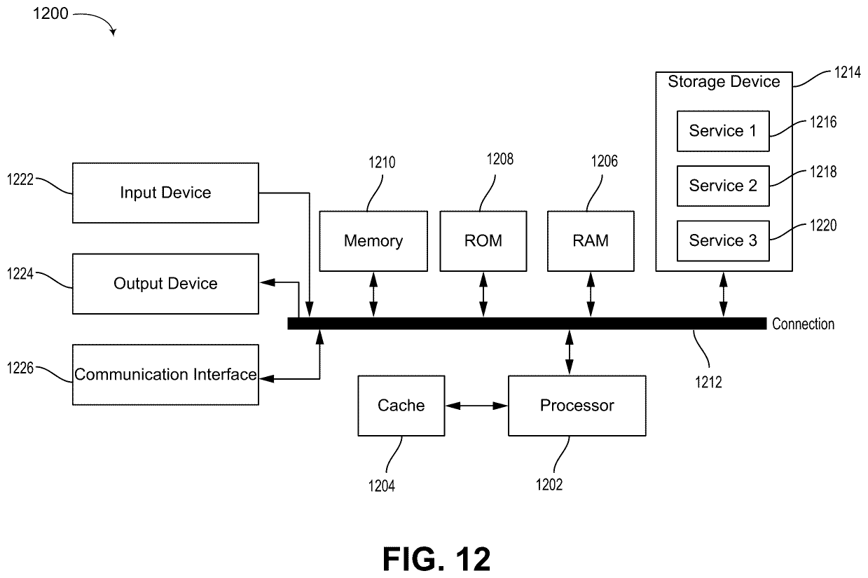

In some examples, as noted previously, the methods described herein (e.g., process 900 of FIG. 9, and/or other methods described herein) can be performed, in whole or in part, by a computing device or apparatus. In one example, one or more of the methods can be performed by XR system 110 of FIG. 1, or by another system or device. In another example, one or more of the methods (e.g., process 900 of FIG. 9, and/or other methods described herein) can be performed, in whole or in part, by the computing-device architecture 1200 shown in FIG. 12. For instance, a computing device with the computing-device architecture 1200 shown in FIG. 12 can include, or be included in, the components of system 400 of FIG. 4, machine-learning model 402 of FIG. 4, system 500 of FIG. 5, machine-learning model 502 of FIG. 5, system 600 of FIG. 6, machine-learning model 602 of FIG. 6, system 700 of FIG. 7, machine-learning model 702 of FIG. 7, renderer 732 of FIG. 7, neural network 736, of FIG. 7, renderer 740 of FIG. 7, system 800 of FIG. 8, and/or machine-learning model 802 of FIG. 8 and can implement the operations of process 900, and/or other process described herein. In some cases, the computing device or apparatus can include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device can include a display, a network interface configured to communicate and/or receive the data, any combination thereof, and/or other component(s). The network interface can be configured to communicate and/or receive Internet Protocol (IP) based data or other type of data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

Process 900, and/or other process described herein are illustrated as logical flow diagrams, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, process 900, and/or other process described herein can be performed under the control of one or more computer systems configured with executable instructions and can be implemented as code (e.g., executable instructions, one or more computer programs, or one or more applications) executing collectively on one or more processors, by hardware, or combinations thereof. As noted above, the code can be stored on a computer-readable or machine-readable storage medium, for example, in the form of a computer program comprising a plurality of instructions executable by one or more processors. The computer-readable or machine-readable storage medium can be non-transitory.

As noted above, various aspects of the present disclosure can use machine-learning models or systems.

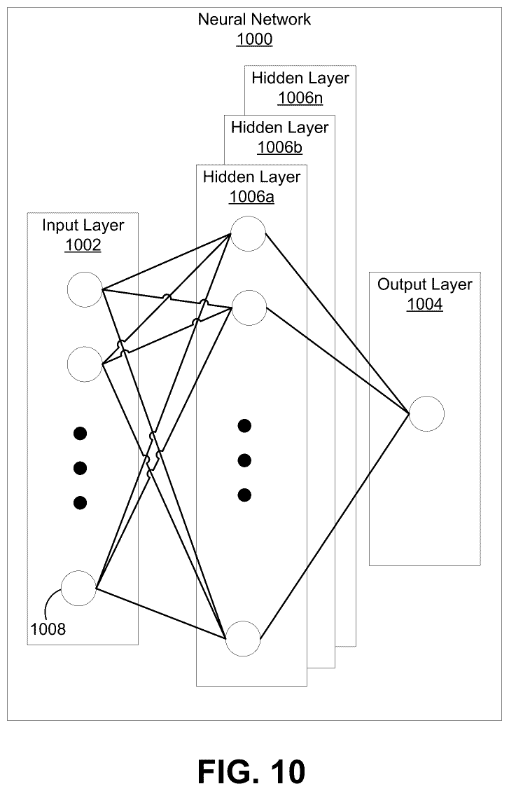

FIG. 10 is an illustrative example of a neural network 1000 (e.g., a deep-learning neural network) that can be used to implement the machine-learning based encoding (including encoding of images, audio data, and/or views), decoding (including decoding of images, audio data, and/or views), feature segmentation, implicit-neural-representation generation, rendering, and/or classification described above. Neural network 1000 may be an example of, or may implement, any of machine-learning model 402 of FIG. 4, machine-learning model 502 of FIG. 5, machine-learning model 602 of FIG. 6, machine-learning model 702 of FIG. 7, encoder 714 of FIG. 7, encoder 716 of FIG. 7, encoder 718 of FIG. 7, encoder 720 of FIG. 7, encoder 730 of FIG. 7, renderer 732 of FIG. 7, neural network 736 of FIG. 7, renderer 740 of FIG. 7, machine-learning model 802 of FIG. 8, encoder 814 of FIG. 8, encoder 816 of FIG. 8, encoder 818 of FIG. 8, encoder 820 of FIG. 8, encoder 822 of FIG. 8, encoder 832 of FIG. 8, encoder 834 of FIG. 8, encoder 836 of FIG. 8, encoder 838 of FIG. 8, encoder 840 of FIG. 8, and/or encoder 842 of FIG. 8.

An input layer 1002 includes input data. In one illustrative example, input layer 1002 can include data representing image data (e.g., one or more images of one or both eyes of face of a user and/or an image of a mouth of the user), audio data (e.g., audio data representative of utterances of the user) view data, and/or features based thereon. Neural network 1000 includes multiple hidden layers hidden layers 1006a, 1006b, through 1006n. The hidden layers 1006a, 1006b, through hidden layer 1006n include “n” number of hidden layers, where “n” is an integer greater than or equal to one. The number of hidden layers can be made to include as many layers as needed for the given application. Neural network 1000 further includes an output layer 1004 that provides an output resulting from the processing performed by the hidden layers 1006a, 1006b, through 1006n. In one illustrative example, output layer 1004 can provide features based on any of the inputs (e.g., features based on images, features based on audio data and/or features based on views) and/or combinations of the inputs.

Neural network 1000 may be, or may include, a multi-layer neural network of interconnected nodes. Each node can represent a piece of information. Information associated with the nodes is shared among the different layers and each layer retains information as information is processed. In some cases, neural network 1000 can include a feed-forward network, in which case there are no feedback connections where outputs of the network are fed back into itself. In some cases, neural network 1000 can include a recurrent neural network, which can have loops that allow information to be carried across nodes while reading in input.

Information can be exchanged between nodes through node-to-node interconnections between the various layers. Nodes of input layer 1002 can activate a set of nodes in the first hidden layer 1006a. For example, as shown, each of the input nodes of input layer 1002 is connected to each of the nodes of the first hidden layer 1006a. The nodes of first hidden layer 1006a can transform the information of each input node by applying activation functions to the input node information. The information derived from the transformation can then be passed to and can activate the nodes of the next hidden layer 1006b, which can perform their own designated functions. Example functions include convolutional, up-sampling, data transformation, and/or any other suitable functions. The output of the hidden layer 1006b can then activate nodes of the next hidden layer, and so on. The output of the last hidden layer 1006n can activate one or more nodes of the output layer 1004, at which an output is provided. In some cases, while nodes (e.g., node 1008) in neural network 1000 are shown as having multiple output lines, a node has a single output and all lines shown as being output from a node represent the same output value.

In some cases, each node or interconnection between nodes can have a weight that is a set of parameters derived from the training of neural network 1000. Once neural network 1000 is trained, it can be referred to as a trained neural network, which can be used to perform one or more operations. For example, an interconnection between nodes can represent a piece of information learned about the interconnected nodes. The interconnection can have a tunable numeric weight that can be tuned (e.g., based on a training dataset), allowing neural network 1000 to be adaptive to inputs and able to learn as more and more data is processed.

Neural network 1000 may be pre-trained to process the features from the data in the input layer 1002 using the different hidden layers 1006a, 1006b, through 1006n in order to provide the output through the output layer 1004. In an example in which neural network 1000 is used to identify features in images, neural network 1000 can be trained using training data that includes both images and labels, as described above. For instance, training images can be input into the network, with each training image having a label indicating the features in the images (for the feature-segmentation machine-learning system) or a label indicating classes of an activity in each image. In one example using object classification for illustrative purposes, a training image can include an image of a number 2, in which case the label for the image can be [0 0 1 0 0 0 0 0 0 0].

In some cases, neural network 1000 can adjust the weights of the nodes using a training process called backpropagation. As noted above, a backpropagation process can include a forward pass, a loss function, a backward pass, and a weight update. The forward pass, loss function, backward pass, and parameter update is performed for one training iteration. The process can be repeated for a certain number of iterations for each set of training images until neural network 1000 is trained well enough so that the weights of the layers are accurately tuned.

For the example of identifying objects in images, the forward pass can include passing a training image through neural network 1000. The weights are initially randomized before neural network 1000 is trained. As an illustrative example, an image can include an array of numbers representing the pixels of the image. Each number in the array can include a value from 0 to 255 describing the pixel intensity at that position in the array. In one example, the array can include a 28×28×3 array of numbers with 28 rows and 28 columns of pixels and 3 color components (such as red, green, and blue, or luma and two chroma components, or the like).

As noted above, for a first training iteration for neural network 1000, the output will likely include values that do not give preference to any particular class due to the weights being randomly selected at initialization. For example, if the output is a vector with probabilities that the object includes different classes, the probability value for each of the different classes can be equal or at least very similar (e.g., for ten possible classes, each class can have a probability value of 0.1). With the initial weights, neural network 1000 is unable to determine low-level features and thus cannot make an accurate determination of what the classification of the object might be. A loss function can be used to analyze error in the output. Any suitable loss function definition can be used, such as a cross-entropy loss. Another example of a loss function includes the mean squared error (MSE), defined as Eₜₒₜₐₗ=Σ½(target−output)². The loss can be set to be equal to the value of Eₜₒₜₐₗ.

The loss (or error) will be high for the first training images since the actual values will be much different than the predicted output. The goal of training is to minimize the amount of loss so that the predicted output is the same as the training label. Neural network 1000 can perform a backward pass by determining which inputs (weights) most contributed to the loss of the network and can adjust the weights so that the loss decreases and is eventually minimized. A derivative of the loss with respect to the weights (denoted as dL/dW, where W are the weights at a particular layer) can be computed to determine the weights that contributed most to the loss of the network. After the derivative is computed, a weight update can be performed by updating all the weights of the filters. For example, the weights can be updated so that they change in the opposite direction of the gradient. The weight update can be denoted as w=wᵢ−ηdL/dW, where w denotes a weight, wᵢ denotes the initial weight, and η denotes a learning rate. The learning rate can be set to any suitable value, with a high learning rate including larger weight updates and a lower value indicating smaller weight updates.

Neural network 1000 can include any suitable deep network. One example includes a convolutional neural network (CNN), which includes an input layer and an output layer, with multiple hidden layers between the input and out layers. The hidden layers of a CNN include a series of convolutional, nonlinear, pooling (for downsampling), and fully connected layers. Neural network 1000 can include any other deep network other than a CNN, such as an autoencoder, a deep belief nets (DBNs), a Recurrent Neural Networks (RNNs), among others.

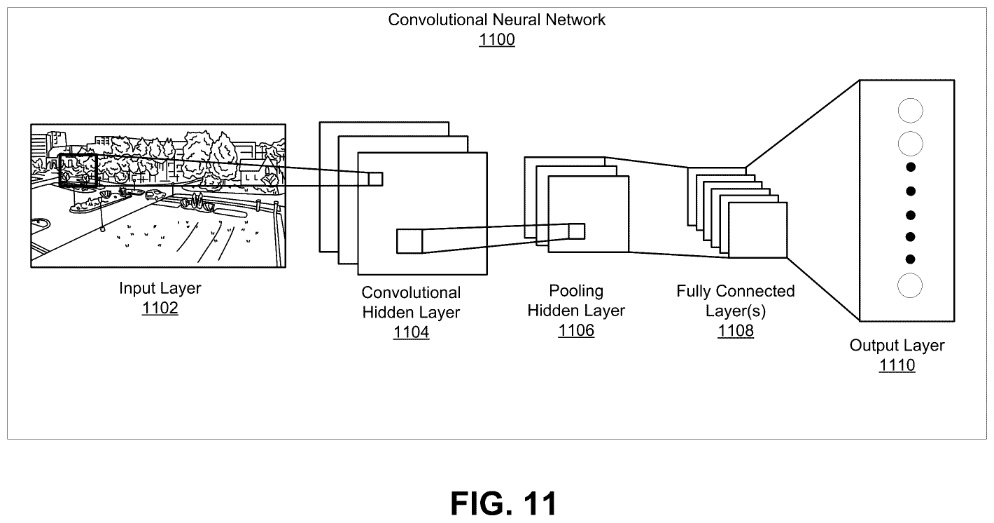

FIG. 11 is an illustrative example of a convolutional neural network (CNN) 1100. The input layer 1102 of the CNN 1100 includes data representing an image or frame. For example, the data can include an array of numbers representing the pixels of the image, with each number in the array including a value from 0 to 255 describing the pixel intensity at that position in the array. Using the previous example from above, the array can include a 28×28×3 array of numbers with 28 rows and 28 columns of pixels and 3 color components (e.g., red, green, and blue, or luma and two chroma components, or the like). The image can be passed through a convolutional hidden layer 1104, an optional non-linear activation layer, a pooling hidden layer 1106, and fully connected layer 1108 (which fully connected layer 1108 can be hidden) to get an output at the output layer 1110. While only one of each hidden layer is shown in FIG. 11, one of ordinary skill will appreciate that multiple convolutional hidden layers, non-linear layers, pooling hidden layers, and/or fully connected layers can be included in the CNN 1100. As previously described, the output can indicate a single class of an object or can include a probability of classes that best describe the object in the image.

The first layer of the CNN 1100 can be the convolutional hidden layer 1104. The convolutional hidden layer 1104 can analyze image data of the input layer 1102. Each node of the convolutional hidden layer 1104 is connected to a region of nodes (pixels) of the input image called a receptive field. The convolutional hidden layer 1104 can be considered as one or more filters (each filter corresponding to a different activation or feature map), with each convolutional iteration of a filter being a node or neuron of the convolutional hidden layer 1104. For example, the region of the input image that a filter covers at each convolutional iteration would be the receptive field for the filter. In one illustrative example, if the input image includes a 28×28 array, and each filter (and corresponding receptive field) is a 5×5 array, then there will be 24×24 nodes in the convolutional hidden layer 1104. Each connection between a node and a receptive field for that node learns a weight and, in some cases, an overall bias such that each node learns to analyze its particular local receptive field in the input image. Each node of the convolutional hidden layer 1104 will have the same weights and bias (called a shared weight and a shared bias). For example, the filter has an array of weights (numbers) and the same depth as the input. A filter will have a depth of 3 for an image frame example (according to three color components of the input image). An illustrative example size of the filter array is 5×5×3, corresponding to a size of the receptive field of a node.

The convolutional nature of the convolutional hidden layer 1104 is due to each node of the convolutional layer being applied to its corresponding receptive field. For example, a filter of the convolutional hidden layer 1104 can begin in the top-left corner of the input image array and can convolve around the input image. As noted above, each convolutional iteration of the filter can be considered a node or neuron of the convolutional hidden layer 1104. At each convolutional iteration, the values of the filter are multiplied with a corresponding number of the original pixel values of the image (e.g., the 5×5 filter array is multiplied by a 5×5 array of input pixel values at the top-left corner of the input image array). The multiplications from each convolutional iteration can be summed together to obtain a total sum for that iteration or node. The process is next continued at a next location in the input image according to the receptive field of a next node in the convolutional hidden layer 1104. For example, a filter can be moved by a step amount (referred to as a stride) to the next receptive field. The stride can be set to 1 or any other suitable amount. For example, if the stride is set to 1, the filter will be moved to the right by 1 pixel at each convolutional iteration. Processing the filter at each unique location of the input volume produces a number representing the filter results for that location, resulting in a total sum value being determined for each node of the convolutional hidden layer 1104.

The mapping from the input layer to the convolutional hidden layer 1104 is referred to as an activation map (or feature map). The activation map includes a value for each node representing the filter results at each location of the input volume. The activation map can include an array that includes the various total sum values resulting from each iteration of the filter on the input volume. For example, the activation map will include a 24×24 array if a 5×5 filter is applied to each pixel (a stride of 1) of a 28×28 input image. The convolutional hidden layer 1104 can include several activation maps in order to identify multiple features in an image. The example shown in FIG. 11 includes three activation maps. Using three activation maps, the convolutional hidden layer 1104 can detect three different kinds of features, with each feature being detectable across the entire image.

In some examples, a non-linear hidden layer can be applied after the convolutional hidden layer 1104. The non-linear layer can be used to introduce non-linearity to a system that has been computing linear operations. One illustrative example of a non-linear layer is a rectified linear unit (ReLU) layer. A ReLU layer can apply the function f(x)=max(0, x) to all of the values in the input volume, which changes all the negative activations to 0. The ReLU can thus increase the non-linear properties of the CNN 1100 without affecting the receptive fields of the convolutional hidden layer 1104.

The pooling hidden layer 1106 can be applied after the convolutional hidden layer 1104 (and after the non-linear hidden layer when used). The pooling hidden layer 1106 is used to simplify the information in the output from the convolutional hidden layer 1104. For example, the pooling hidden layer 1106 can take each activation map output from the convolutional hidden layer 1104 and generates a condensed activation map (or feature map) using a pooling function. Max-pooling is one example of a function performed by a pooling hidden layer. Other forms of pooling functions be used by the pooling hidden layer 1106, such as average pooling, L2-norm pooling, or other suitable pooling functions. A pooling function (e.g., a max-pooling filter, an L2-norm filter, or other suitable pooling filter) is applied to each activation map included in the convolutional hidden layer 1104. In the example shown in FIG. 11, three pooling filters are used for the three activation maps in the convolutional hidden layer 1104.

In some examples, max-pooling can be used by applying a max-pooling filter (e.g., having a size of 2×2) with a stride (e.g., equal to a dimension of the filter, such as a stride of 2) to an activation map output from the convolutional hidden layer 1104. The output from a max-pooling filter includes the maximum number in every sub-region that the filter convolves around. Using a 2×2 filter as an example, each unit in the pooling layer can summarize a region of 2×2 nodes in the previous layer (with each node being a value in the activation map). For example, four values (nodes) in an activation map will be analyzed by a 2×2 max-pooling filter at each iteration of the filter, with the maximum value from the four values being output as the “max” value. If such a max-pooling filter is applied to an activation filter from the convolutional hidden layer 1104 having a dimension of 24×24 nodes, the output from the pooling hidden layer 1106 will be an array of 12×12 nodes.

In some examples, an L2-norm pooling filter could also be used. The L2-norm pooling filter includes computing the square root of the sum of the squares of the values in the 2×2 region (or other suitable region) of an activation map (instead of computing the maximum values as is done in max-pooling) and using the computed values as an output.

The pooling function (e.g., max-pooling, L2-norm pooling, or other pooling function) determines whether a given feature is found anywhere in a region of the image and discards the exact positional information. This can be done without affecting results of the feature detection because, once a feature has been found, the exact location of the feature is not as important as its approximate location relative to other features. Max-pooling (as well as other pooling methods) offer the benefit that there are many fewer pooled features, thus reducing the number of parameters needed in later layers of the CNN 1100.

The final layer of connections in the network is a fully-connected layer that connects every node from the pooling hidden layer 1106 to every one of the output nodes in the output layer 1110. Using the example above, the input layer includes 28×28 nodes encoding the pixel intensities of the input image, the convolutional hidden layer 1104 includes 3×24×24 hidden feature nodes based on application of a 5×5 local receptive field (for the filters) to three activation maps, and the pooling hidden layer 1106 includes a layer of 3×12×12 hidden feature nodes based on application of max-pooling filter to 2×2 regions across each of the three feature maps. Extending this example, the output layer 1110 can include ten output nodes. In such an example, every node of the 3×12×12 pooling hidden layer 1106 is connected to every node of the output layer 1110.

The fully connected layer 1108 can obtain the output of the previous pooling hidden layer 1106 (which should represent the activation maps of high-level features) and determines the features that most correlate to a particular class. For example, the fully connected layer 1108 can determine the high-level features that most strongly correlate to a particular class and can include weights (nodes) for the high-level features. A product can be computed between the weights of the fully connected layer 1108 and the pooling hidden layer 1106 to obtain probabilities for the different classes. For example, if the CNN 1100 is being used to predict that an object in an image is a person, high values will be present in the activation maps that represent high-level features of people (e.g., two legs are present, a face is present at the top of the object, two eyes are present at the top left and top right of the face, a nose is present in the middle of the face, a mouth is present at the bottom of the face, and/or other features common for a person).

In some examples, the output from the output layer 1110 can include an M-dimensional vector (in the prior example, M=10). M indicates the number of classes that the CNN 1100 has to choose from when classifying the object in the image. Other example outputs can also be provided. Each number in the M-dimensional vector can represent the probability the object is of a certain class. In one illustrative example, if a 10-dimensional output vector represents ten different classes of objects is [0 0 0.05 0.8 0 0.15 0 0 0 0], the vector indicates that there is a 5% probability that the image is the third class of object (e.g., a dog), an 80% probability that the image is the fourth class of object (e.g., a human), and a 15% probability that the image is the sixth class of object (e.g., a kangaroo). The probability for a class can be considered a confidence level that the object is part of that class.

FIG. 12 illustrates an example computing-device architecture 1200 of an example computing device which can implement the various techniques described herein. In some examples, the computing device can include a mobile device, a wearable device, an extended reality device (e.g., a virtual reality (VR) device, an augmented reality (AR) device, or a mixed reality (MR) device), a personal computer, a laptop computer, a video server, a vehicle (or computing device of a vehicle), or other device. For example, the computing-device architecture 1200 may include, implement, or be included in any or all of system 400 of FIG. 4, machine-learning model 402 of FIG. 4, system 500 of FIG. 5, machine-learning model 502 of FIG. 5, system 600 of FIG. 6, machine-learning model 602 of FIG. 6, system 700 of FIG. 7, machine-learning model 702 of FIG. 7, renderer 732 of FIG. 7, neural network 736, of FIG. 7, renderer 740 of FIG. 7, system 800 of FIG. 8, and/or machine-learning model 802 of FIG. 8.

The components of computing-device architecture 1200 are shown in electrical communication with each other using connection 1212, such as a bus. The example computing-device architecture 1200 includes a processing unit (CPU or processor) 1202 and computing device connection 1212 that couples various computing device components including computing device memory 1210, such as read only memory (ROM) 1208 and random-access memory (RAM) 1206, to processor 1202.

Computing-device architecture 1200 can include a cache of high-speed memory connected directly with, in close proximity to, or integrated as part of processor 1202. Computing-device architecture 1200 can copy data from memory 1210 and/or the storage device 1214 to cache 1204 for quick access by processor 1202. In this way, the cache can provide a performance boost that avoids processor 1202 delays while waiting for data. These and other modules can control or be configured to control processor 1202 to perform various actions. Other computing device memory 1210 may be available for use as well. Memory 1210 can include multiple different types of memory with different performance characteristics. Processor 1202 can include any general-purpose processor and a hardware or software service, such as service 1 1216, service 2 1218, and service 3 1220 stored in storage device 1214, configured to control processor 1202 as well as a special-purpose processor where software instructions are incorporated into the processor design. Processor 1202 may be a self-contained system, containing multiple cores or processors, a bus, memory controller, cache, etc. A multi-core processor may be symmetric or asymmetric.

To enable user interaction with the computing-device architecture 1200, input device 1222 can represent any number of input mechanisms, such as a microphone for speech, a touch-sensitive screen for gesture or graphical input, keyboard, mouse, motion input, speech and so forth. Output device 1224 can also be one or more of a number of output mechanisms known to those of skill in the art, such as a display, projector, television, speaker device, etc. In some instances, multimodal computing devices can enable a user to provide multiple types of input to communicate with computing-device architecture 1200. Communication interface 1226 can generally govern and manage the user input and computing device output. There is no restriction on operating on any particular hardware arrangement and therefore the basic features here may easily be substituted for improved hardware or firmware arrangements as they are developed.

Storage device 1214 is a non-volatile memory and can be a hard disk or other types of computer readable media which can store data that are accessible by a computer, such as magnetic cassettes, flash memory cards, solid state memory devices, digital versatile disks, cartridges, random-access memories (RAMs) 1206, read only memory (ROM) 1208, and hybrids thereof. Storage device 1214 can include services 1216, 1218, and 1220 for controlling processor 1202. Other hardware or software modules are contemplated. Storage device 1214 can be connected to the computing device connection 1212. In one aspect, a hardware module that performs a particular function can include the software component stored in a computer-readable medium in connection with the necessary hardware components, such as processor 1202, connection 1212, output device 1224, and so forth, to carry out the function.

The term “substantially,” in reference to a given parameter, property, or condition, may refer to a degree that one of ordinary skill in the art would understand that the given parameter, property, or condition is met with a small degree of variance, such as, for example, within acceptable manufacturing tolerances. By way of example, depending on the particular parameter, property, or condition that is substantially met, the parameter, property, or condition may be at least 90% met, at least 95% met, or even at least 99% met.

Aspects of the present disclosure are applicable to any suitable electronic device (such as security systems, smartphones, tablets, laptop computers, vehicles, drones, or other devices) including or coupled to one or more active depth sensing systems. While described below with respect to a device having or coupled to one light projector, aspects of the present disclosure are applicable to devices having any number of light projectors and are therefore not limited to specific devices.

The term “device” is not limited to one or a specific number of physical objects (such as one smartphone, one controller, one processing system and so on). As used herein, a device may be any electronic device with one or more parts that may implement at least some portions of this disclosure. While the below description and examples use the term “device” to describe various aspects of this disclosure, the term “device” is not limited to a specific configuration, type, or number of objects. Additionally, the term “system” is not limited to multiple components or specific aspects. For example, a system may be implemented on one or more printed circuit boards or other substrates and may have movable or static components. While the below description and examples use the term “system” to describe various aspects of this disclosure, the term “system” is not limited to a specific configuration, type, or number of objects.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including functional blocks including devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, magnetic or optical disks, USB devices provided with non-volatile memory, networked storage devices, any suitable combination thereof, among others. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some aspects the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

The various illustrative logical blocks, modules, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general-purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium including program code including instructions that, when executed, performs one or more of the methods described above. The computer-readable data storage medium may form part of a computer program product, which may include packaging materials. The computer-readable medium may include memory or data storage media, such as random-access memory (RAM) such as synchronous dynamic random-access memory (SDRAM), read-only memory (ROM), non-volatile random-access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general-purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration). Accordingly, the term “processor,” as used herein may refer to any of the foregoing structure, any combination of the foregoing structure, or any other structure or apparatus suitable for implementation of the techniques described herein.

Claim language or other language reciting “at least one processor configured to,” “at least one processor being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Illustrative aspects of the disclosure include:

Aspect 1. An apparatus for generating models of faces, the apparatus comprising: at least one memory; and at least one processor coupled to the at least one memory and configured to: obtain one or more images of one or both eyes of a face of a user; obtain audio data based on utterances of the user; and generate, using a machine-learning model, a three-dimensional model of the face of the user based on the one or more images and the audio data.

Aspect 2. The apparatus of aspect 1, wherein a mouth portion of the three-dimensional model of the face is based on the audio data.

Aspect 3. The apparatus of any one of aspects 1 or 2, wherein the three-dimensional model comprises a three-dimensional morphable model (3DMM) of the face.

Aspect 4. The apparatus of anyone of aspects 1 to 3, wherein the three-dimensional model comprises a plurality of vertices corresponding to points of the face.

Aspect 5. The apparatus of any one of aspects 1 to 4, wherein the at least one processor is further configured to obtain a view for the three-dimensional model of the face, wherein the three-dimensional model of the face is generated based on the view.

Aspect 6. The apparatus of aspect 5, wherein the view for the three-dimensional model of the face is based on an angle from which the three-dimensional model of the face is to be viewed.

Aspect 7. The apparatus of any one of aspects 1 to 6, wherein the audio data comprises perception-based representation of the utterances of the user.

Aspect 8. The apparatus of aspect 7, wherein the perception-based representation of the utterances comprises a representation of the audio data based on perceptually-relevant frequencies and perceptually-relevant amplitudes.

Aspect 9. The apparatus of any one of aspects 1 to 8, wherein the audio data comprises a Mel spectrogram representative of the utterances of the user.

Aspect 10. The apparatus of any one of aspects 1 to 9, wherein the machine-learning model comprises a first machine-learning encoder and wherein the at least one processor is further configured to: generate image-based features based on the one or more images of the one or both eyes of the user using one or more machine-learning encoders; generate audio features based on the audio data using a second machine-learning encoder; and generate the three-dimensional model of the face based on the image-based features and audio features using the first machine-learning encoder.

Aspect 11. The apparatus of aspect 10, wherein the at least one processor is further configured to: obtain a view for the three-dimensional model of the face; and generate view features based on the view using a third machine-learning encoder; wherein the three-dimensional model of the face is generated based on the view features.

Aspect 12. The apparatus of aspect 11, wherein the view for the three-dimensional model of the face is based on an angle from which the three-dimensional model of the face is to be viewed.

Aspect 13. The apparatus of anyone of aspects 10 to 12, wherein the at least one processor is further configured to: generate a UV map of the face based on the three-dimensional model of the face using a first renderer; generate a texture map based on the UV map of the face using a machine-learning encoder-decoder; and render the three-dimensional model of the face based on the three-dimensional model of the face and the texture map using a second renderer.

Aspect 14. The apparatus of any one of aspects 1 to 13, wherein the at least one processor is further configured to obtain an image of at least a portion of a mouth of the face of the user, wherein the three-dimensional model of the face is generated based on the image of at least the portion of the mouth of the face.

Aspect 15. A method for generating models of faces, the method comprising: obtaining one or more images of one or both eyes of a face of a user; obtaining audio data based on utterances of the user; and generating, using a machine-learning model, a three-dimensional model of the face of the user based on the one or more images and the audio data.

Aspect 16. The method of aspect 15, wherein a mouth portion of the three-dimensional model of the face is based on the audio data.

Aspect 17. The method of any one of aspects 15 or 16, wherein the three-dimensional model comprises a three-dimensional morphable model (3DMM) of the face.

Aspect 18. The method of any one of aspects 15 to 17, wherein the three-dimensional model comprises a plurality of vertices corresponding to points of the face.

Aspect 19. The method of aspects 15 to 18, further comprising obtaining a view for the three-dimensional model of the face, wherein the three-dimensional model of the face is generated based on the view.

Aspect 20. The method of aspect 19, wherein the view for the three-dimensional model of the face is based on an angle from which the three-dimensional model of the face is to be viewed.

Aspect 21. The method of aspects 15 to 20, wherein the audio data comprises perception-based representation of the utterances of the user.

Aspect 22. The method of aspect 21, wherein the perception-based representation of the utterances comprises a representation of the audio data based on perceptually-relevant frequencies and perceptually-relevant amplitudes.

Aspect 23. The method of aspects 15 to 22, wherein the audio data comprises a Mel spectrogram representative of the utterances of the user.

Aspect 24. The method of aspects 15 to 23, wherein the machine-learning model comprises a first machine-learning encoder and wherein the method further comprises: generating image-based features based on the one or more images of the one or both eyes of the user using one or more machine-learning encoders; generating audio features based on the audio data using a second machine-learning encoder; and generating the three-dimensional model of the face based on the image-based features and audio features using the first machine-learning encoder.

Aspect 25. The method of aspect 24, further comprising: obtaining a view for the three-dimensional model of the face; and generating view features based on the view using a third machine-learning encoder; wherein the three-dimensional model of the face is generated based on the view features.

Aspect 26. The method of aspect 25, wherein the view for the three-dimensional model of the face is based on an angle from which the three-dimensional model of the face is to be viewed.

Aspect 27. The method of aspects 24 to 26, further comprising: generating a UV map of the face based on the three-dimensional model of the face using a first renderer; generating a texture map based on the UV map of the face using a machine-learning encoder-decoder; and rendering the three-dimensional model of the face based on the three-dimensional model of the face and the texture map using a second renderer.

Aspect 28. The method of aspects 15 to 27, further comprising obtaining an image of at least a portion of a mouth of the face of the user, wherein the three-dimensional model of the face is generated based on the image of at least the portion of the mouth of the face.

Aspect 29. A non-transitory computer-readable storage medium having stored thereon instructions that, when executed by at least one processor, cause the at least one processor to: obtain one or more images of one or both eyes of a face of a user; obtain audio data based on utterances of the user; and generate, using a machine-learning model, a three-dimensional model of the face of the user based on the one or more images and the audio data.

Aspect 30. An apparatus for generating models of faces, the apparatus comprising: means for obtaining one or more images of one or both eyes of a face of a user; means for obtaining audio data based on utterances of the user; and means for generating, using a machine-learning model, a three-dimensional model of the face of the user based on the one or more images and the audio data.

What is claimed is:

1. An apparatus for generating models of faces, the apparatus comprising:
at least one memory; and
at least one processor coupled to the at least one memory and configured to:
obtain one or more images of one or both eyes of a face of a user;
obtain audio data based on utterances of the user; and
generate, using a machine-learning model, a three-dimensional model of the face of the user based on the one or more images and the audio data.

2. The apparatus of claim 1, wherein a mouth portion of the three-dimensional model of the face is based on the audio data.

3. The apparatus of claim 1, wherein the three-dimensional model comprises a three-dimensional morphable model (3DMM) of the face.

4. The apparatus of claim 1, wherein the three-dimensional model comprises a plurality of vertices corresponding to points of the face.

5. The apparatus of claim 1, wherein the at least one processor is further configured to obtain a view for the three-dimensional model of the face, wherein the three-dimensional model of the face is generated based on the view.

6. The apparatus of claim 5, wherein the view for the three-dimensional model of the face is based on an angle from which the three-dimensional model of the face is to be viewed.

7. The apparatus of claim 1, wherein the audio data comprises perception-based representation of the utterances of the user.

8. The apparatus of claim 7, wherein the perception-based representation of the utterances comprises a representation of the audio data based on perceptually-relevant frequencies and perceptually-relevant amplitudes.

9. The apparatus of claim 1, wherein the audio data comprises a Mel spectrogram representative of the utterances of the user.

10. The apparatus of claim 1, wherein the machine-learning model comprises a first machine-learning encoder and wherein the at least one processor is further configured to:
generate image-based features based on the one or more images of the one or both eyes of the user using one or more machine-learning encoders;
generate audio features based on the audio data using a second machine-learning encoder; and
generate the three-dimensional model of the face based on the image-based features and audio features using the first machine-learning encoder.

11. The apparatus of claim 10, wherein the at least one processor is further configured to:
obtain a view for the three-dimensional model of the face; and
generate view features based on the view using a third machine-learning encoder;
wherein the three-dimensional model of the face is generated based on the view features.

12. The apparatus of claim 11, wherein the view for the three-dimensional model of the face is based on an angle from which the three-dimensional model of the face is to be viewed.

13. The apparatus of claim 10, wherein the at least one processor is further configured to:
generate a UV map of the face based on the three-dimensional model of the face using a first renderer;
generate a texture map based on the UV map of the face using a machine-learning encoder-decoder; and
render the three-dimensional model of the face based on the three-dimensional model of the face and the texture map using a second renderer.

14. The apparatus of claim 1, wherein the at least one processor is further configured to obtain an image of at least a portion of a mouth of the face of the user, and wherein the three-dimensional model of the face is generated based on the image of at least the portion of the mouth of the face.

15. A method for generating models of faces, the method comprising:
obtaining one or more images of one or both eyes of a face of a user;
obtaining audio data based on utterances of the user; and
generating, using a machine-learning model, a three-dimensional model of the face of the user based on the one or more images and the audio data.

16. The method of claim 15, wherein a mouth portion of the three-dimensional model of the face is based on the audio data.

17. The method of claim 15, wherein the three-dimensional model comprises a three-dimensional morphable model (3DMM) of the face.

18. The method of claim 15, wherein the three-dimensional model comprises a plurality of vertices corresponding to points of the face.

19. The method of claim 15, further comprising obtaining a view for the three-dimensional model of the face, wherein the three-dimensional model of the face is generated based on the view.

20. The method of claim 19, wherein the view for the three-dimensional model of the face is based on an angle from which the three-dimensional model of the face is to be viewed.

21. The method of claim 15, wherein the audio data comprises perception-based representation of the utterances of the user.

22. The method of claim 21, wherein the perception-based representation of the utterances comprises a representation of the audio data based on perceptually-relevant frequencies and perceptually-relevant amplitudes.

23. The method of claim 15, wherein the audio data comprises a Mel spectrogram representative of the utterances of the user.

24. The method of claim 15, wherein the machine-learning model comprises a first machine-learning encoder and wherein the method further comprises:
generating image-based features based on the one or more images of the one or both eyes of the user using one or more machine-learning encoders;
generating audio features based on the audio data using a second machine-learning encoder; and
generating the three-dimensional model of the face based on the image-based features and audio features using the first machine-learning encoder.

25. The method of claim 24, further comprising:
obtaining a view for the three-dimensional model of the face; and
generating view features based on the view using a third machine-learning encoder;
wherein the three-dimensional model of the face is generated based on the view features.

26. The method of claim 25, wherein the view for the three-dimensional model of the face is based on an angle from which the three-dimensional model of the face is to be viewed.

27. The method of claim 24, further comprising:
generating a UV map of the face based on the three-dimensional model of the face using a first renderer;
generating a texture map based on the UV map of the face using a machine-learning encoder-decoder; and
rendering the three-dimensional model of the face based on the three-dimensional model of the face and the texture map using a second renderer.

28. The method of claim 15, further comprising obtaining an image of at least a portion of a mouth of the face of the user, wherein the three-dimensional model of the face is generated based on the image of at least the portion of the mouth of the face.

29. A non-transitory computer-readable storage medium having stored thereon instructions that, when executed by at least one processor, cause the at least one processor to:
obtain one or more images of one or both eyes of a face of a user;
obtain audio data based on utterances of the user; and
generate, using a machine-learning model, a three-dimensional model of the face of the user based on the one or more images and the audio data.

30. An apparatus for generating models of faces, the apparatus comprising:
means for obtaining one or more images of one or both eyes of a face of a user;
means for obtaining audio data based on utterances of the user; and
means for generating, using a machine-learning model, a three-dimensional model of the face of the user based on the one or more images and the audio data.
